(19) United States
(12) Patent Application Publication
(10) Pub. No.: US 2020/0164938 A1
(43) Pub. Date: May 28, 2020

(54) SWITCHABLE SIDE SUPPORT DEVICE FOR CYCLES AND USE THEREOF AND METHOD FOR COUPLING THE SIDE SUPPORT DEVICE TO A DRIVE TRACTION MEANS OF THE CYCLE

(71) Applicant: Walfred BUCHWALD, Dinslaken (DE)

(72) Inventor: Walfred BUCHWALD, Dinslaken (DE)

(21) Appl. No.: 16/627,305

(22) PCT Filed: Jun. 27, 2018
(86) PCT No.: PCT/DE2018/100593

§ 371 Date: Feb. 3, 2020

(30) Foreign Application Priority Data
Jun. 28, 2017 (DE) 10 2017 006 504.7

(51) Int. Cl. B62H 1/06; B62H 1/12

(52) U.S. Cl. CPC B62H 1/06; B62H 1/12

(57) ABSTRACT

When riding or parking cycles, a support aid is expedient in many situations. Side supports for cycles, configured for permanently mounting on the cycle and for laterally supporting the cycle when stationary with or without a rider, or during riding, have at least one side stand mechanism (13) with at least one supporting wheel (13.9), which supporting wheel can be positioned in at least one height position. According to the invention, the side support device is switchable and has a gear device (14) which is coupled to the supporting wheel and is configured for positioning the supporting wheel in at least two height positions comprising at least one extended supporting height position and at least one retracted height position for support-free riding with the cycle. Robustness and flexibility can thereby be especially ensured. The invention also relates to the use of individual components of the side support device and to a method for coupling the side support device to a drive traction means of the cycle.

### TECHNICAL FIELD

The present invention relates to a side support apparatus for two-wheeled vehicles which functions in the simplest possible manner. The present invention furthermore relates to the use thereof on a vehicle with at least one wheel, in particular on a two-wheeled vehicle. The present invention furthermore also relates to a method for the (movement) linking of the side support apparatus to a drive traction mechanism of the two-wheeled vehicle, in particular for the activation of a functionality of the side support apparatus. In particular, the invention relates to an apparatus and to a method as per the preamble of the respective independent claim.

### BACKGROUND OF THE INVENTION

Riding two-wheeled vehicles involves a certain degree of risk, in particular on smooth, slippery underlying surfaces, or in heavy traffic, or if the rider is relatively weak, infirm and/or inattentive or inexperienced or, in certain situations, simply overburdened. With decreasing speed, any two-wheeled vehicle becomes unstable. When stationary, it tips to one side. In various usage applications, there is therefore a demand to design a two-wheeled vehicle to be safer, in particular with regard to balance and standing characteristics, standing stability, tipping stability, and also ensuring more stable riding characteristics at low speeds or in specific situations. There is also an interest in simplifying the handling of the two-wheeled vehicle in the case of frequent stoppage. What is ultimately of importance is not only safety but also a high level of riding comfort, for example also for relatively elderly persons.

It is an object to provide an apparatus and a method with which the riding of a two-wheeled vehicle can be made possible with a high level of safety and as far as possible also a high level of comfort. It is also an object to provide a two-wheeled vehicle, in particular bicycle, with more stable standing or travel characteristics, in particular in accordance with the desire of the rider. Not least, it is an object to configure an apparatus and a method for supporting a two-wheeled vehicle such that the functionality of the support can be accessed in a simple manner, even for the situation that the two-wheeled vehicle or the rider is in a precarious situation. Here, robustness is also of interest. It is ultimately also sought for integration or retrofitting in the case of two-wheeled vehicles to be possible in as uncomplicated a manner as possible.

### SUMMARY OF THE INVENTION

At least one of these objects is achieved by means of a side support apparatus according to claim 1 and by means of a method according to the coordinate method claim. Advantageous refinements of the invention will be discussed in the respective subclaims. The features of the exemplary embodiments described below are combinable with one another unless explicitly stated otherwise.

A side support apparatus for two-wheeled vehicles is provided, said side support apparatus being configured for permanent installation on the two-wheeled vehicle and for laterally supporting the two-wheeled vehicle when stationary with or without a rider or during travel, wherein the side support apparatus has at least one side stand mechanism with at least one support wheel, which support wheel is positionable in at least one height position. It is proposed according to the invention that the side support apparatus is activatable and deactivatable in terms of its function and has a transmission device which is linked to the support wheel and which, in reaction to or in a manner dependent on an input by the rider or an automated control specification, is configured for positioning the support wheel in at least two height positions comprising at least one deployed supporting height position and at least one retracted height position for support-free travel with the two-wheeled vehicle.

This permits the use of the support wheel in a wide variety of situations, be it during travel or when stationary. The height positions may be selected in accordance with the traveling situation, and it is possible to switch between the height positions entirely without problems, in particular by means of an actuating device which is accessible for example on a handlebar of the two-wheeled vehicle. The rider can then spontaneously decide whether or not a support function is desired. The individual height positions may be set in step or continuously variable fashion between a highest (retracted) and a lowest (deployed) height position, wherein it is also possible for a difference of for example ±5 cm to be set between the height positions of opposite side stand mechanisms.

In particular, it is no longer necessary to dismount from the two-wheeled vehicle, be it at low speeds or when stationary. This also permits savings in expenditure of effort. A stabilization in braking characteristics can also be realized by means of such an apparatus. The risk of a crash is considerably reduced.

Be it in the context of two-wheeled vehicles for relatively elderly or ill persons, or be it in the context of bicycles for everyday use, the side support apparatus provides the advantages of the riding style and of the agile riding characteristics of conventional two-wheeled vehicles, in particular without the large track width of three-wheeled vehicles with a fixed chassis.

The side support apparatus may have a holding clamp, which interacts with the transmission device, in particular as a component of a traction mechanism kinematic system or of a Bowden cable system. The holding clamp may in particular comprise a housing in which a spring-controlled, preferably beveled bolt is arranged, which is arranged at the end side of a cantilever of a side stand mechanism and which is mounted so as to be preloaded against the same. The bolt is arranged and configured to engage into the cantilever or to interact with a free end of the cantilever. The bolt may be linked to a cable of the Bowden cable system.

The side support apparatus may have a fixing clamp, which interacts with the transmission device, in particular as a component of a traction mechanism kinematic system. The fixing clamp may in particular comprise a housing in which a spring-controlled, preferably beveled bolt is arranged, which is arranged at the end side of at least one plate of the transmission device and which is mounted so as to be preloaded against the same. The bolt may be linked to a cable of a Bowden cable system.

The two-wheeled vehicle may for example also be a bicycle with an electric drive. Together with the side support apparatus, it is impossible to provide a very comfortable and stable two-wheeled vehicle, which is very safe in traffic, in particular for relatively elderly persons.

Here, coupling is preferably to be understood to mean a process in which machine elements or components are temporarily placed in operative connection with one another, that is to say an activatable or deactivatable mechanical connection.

Linking or a link is preferably to be understood here to mean a permanent connection or an operative connection between multiple components, which link does not necessarily require a coupling process. In particular, the transmission device may be redundantly linked to multiple side stand mechanisms. A link may be realized at least partially by mechanical or else non-mechanical means, in particular also purely electrically. Here, a redundant link is preferably to be understood to mean a link to at least two side stand mechanisms, which side stand mechanisms are provided on the same side or on opposite sides of the two-wheeled vehicle. Here, a redundant link is to be understood to mean a link to at least two branches for the onward transmission of a drive/output movement to the respective side stand mechanisms or support wheels.

Here, a movement link is preferably to be understood to mean a kinetic or kinematic operative connection between multiple components, which link leads to the utilization and onward transmission of a drive/output movement. According to the invention, a movement link may be realized between a two-wheeled vehicle drive traction mechanism and a respective support wheel. Here, a movement link may also be realized between a pedal crank movement of the rider and the height positioning. This, too, is a central aspect of the present invention: the rider themself has power and control over the entire mechanism, in particular by means of a movement that the rider performs in any case. The drive movement or the setting movement may be provided inherently through the standard operation of the two-wheeled vehicle. The effects are no reacclimatizing, intuitive operation, a feeling of a high level of safety, good control, and a high level of trust. All of this leads to an apparatus which is intuitive to control and which makes the riding of a two-wheeled vehicle noticeably easier, without the rider having to reacclimatize themself. The appeal of the movement linking according to the invention also consists in that the respective side stand mechanism can be retracted/pulled up again without additional actuating operations when moving off. The setting or adopting of the height positions may be realized by cranking the pedals or by actuating the drive traction mechanism, in particular exclusively as a result of this. This can ensure simple operation.

In one exemplary embodiment, the side support apparatus is configured for installation on a luggage carrier and/or on a wheel axle of the two-wheeled vehicle. This provides not only the possibility of engagement into a two-wheeled vehicle drive traction mechanism but also relatively stable, robust support.

Here, at least one of the height positions may also be arranged under the ground-contact area of the (rear) wheel of the two-wheeled vehicle. The support wheels can thus be deployed to such a low level that the (rear) wheel is lifted. This may be advantageous for example in the event of repairs being performed on the (rear) wheel. The positioning of the support wheels at a height position lower than the (rear) wheel may be assisted, in particular in the case of support wheels which are deployed purely by means of spring preload, by virtue of the (rear) wheel being manually lifted or at least partially relieved of load.

In one exemplary embodiment, the transmission device is configured for transmitting a drive movement of a two-wheeled vehicle drive traction mechanism to the at least one side stand mechanism. This permits the positioning without further energy sources. The traction power imparted by the rider or by an electric motor for the purposes of driving the two-wheeled vehicle can also be utilized for the positioning of support wheels.

In one exemplary embodiment, the side support apparatus is configured for positioning the support wheel into at least one of the at least two height positions, in particular into the supporting height position, by interaction of the transmission device with a two-wheeled vehicle drive traction mechanism, in particular with a bicycle chain, in particular during travel. This makes it possible for the respective support wheel to be retracted or deployed, in particular counter to a spring force, during travel. A movement opposite to the spring force can then optionally be realized on the basis of a spring force alone. This eliminates the need for a kinematic reversal, and the entire arrangement can remain relatively simple and weight-saving.

In one exemplary embodiment, the side support apparatus has a traction mechanism kinematic system configured for positioning the support wheel in at least one of the height positions by reversible temporary linking of the transmission device to a two-wheeled vehicle drive traction mechanism, in particular to a bicycle chain. This permits a spontaneous activation or deactivation of the support function.

In one exemplary embodiment, the traction mechanism kinematic system is manually linkable by means of an actuating device to the two-wheeled vehicle drive traction mechanism, in particular by means of an actuating lever arranged on a handlebar of the two-wheeled vehicle. This permits easier handling, in particular also for elderly persons. Robustness can also be ensured through the omission of electronic switches or displays, which facilitates intuitive operation in particular for elderly persons.

In one exemplary embodiment, the side support apparatus, in particular the transmission device provides at least two functionalities from the following group: movement linking of the movement of a two-wheeled vehicle drive traction mechanism to a setting movement of at least one support wheel, linking of a manual actuating device to a two-wheeled vehicle drive traction mechanism for the switching of the transmission device, elastic spring mounting for the resiliently elastic positioning of the support wheel in at least one setting movement direction, elastic preloading of at least one spring of the side support apparatus in a first setting movement direction and resiliently elastic setting movement in a second setting movement direction. This provides a wide range of variants of the type of link.

In one exemplary embodiment, at least one functionality of the side support apparatus from the following group is switchable: elastic spring preload induced by a movement of a two-wheeled vehicle drive traction mechanism, resiliently elastic resetting movement by unblocking of a positively locking and/or non-positively locking triggering mechanism, displacement of at least one support wheel in a first setting movement direction and/or second setting movement direction by means of a two-wheeled vehicle drive traction mechanism. This also makes it possible for energy to be temporarily stored and accessed when required, such that a setting movement can be accessed with high safety and reliability even in hectic situations.

In one exemplary embodiment, at least one triggering mechanism or at least one pivoting movement of a traction mechanism kinematic system of the side support apparatus and/or the functionality of the transmission device is activatable in spring-mounted fashion, in particular in each case a setting movement and/or a resetting movement for the positioning of the support wheel in the respective height position. This also permits fast movements, which take place in at least partially automated fashion, with a robust mechanism.

In one exemplary embodiment, the side support apparatus has a traction mechanism kinematic system which is linked to the transmission device such that the side support apparatus is configured for movement linking between a two-wheeled vehicle drive traction mechanism and the support wheel. This provides a drive train which can be easily integrated, in particular also retrofitted, into any two-wheeled vehicle.

In one exemplary embodiment, the side support apparatus is configured for movement linking between a/the two-wheeled vehicle drive traction mechanism and at least one height position by means of a drive train at least comprising a/the transmission shaft, which engages into the two-wheeled vehicle drive traction mechanism, a/the Bowden cable shaft, which is driven by the transmission shaft, and a/the pressure bolt, which is displaceable by means of the Bowden cable shaft, for releasing a triggering mechanism, in particular in this drive sequence for the movement linking in series in this sequence, in particular linked to an actuating device which engages on at least one triggering mechanism. This provides a high degree of automation.

In one exemplary embodiment, a/the traction mechanism kinematic system, which interacts with a transmission device, of the side support apparatus has two plates which are connected to one another by means of a hinge and by means of which the transmission device is switchable. The plates make it possible to realize a robust mechanism and an exactly predefinable change in position, in particular in the range of centimeters or millimeters. In particular, at least one of the plates can be easily displaced by means of a preloaded element which is pressed against the plate, in order to initiate a setting movement of the traction mechanism kinematic system.

In the case of plates being used, there is also the advantage that only a small number of components is required. The hinge provides the advantage that only three components are required. The kinematic system remains slim and robust. In particular, it is possible to omit guides or guide components, for example with regard to guidance of the shaft.

Here, a setting movement may be understood generally to mean a movement, initiated by means of the side support apparatus, of one of the components of the side support apparatus, for example a movement of one of the components of a traction mechanism kinematic system, in particular also the ultimately desired movement of the support wheel. A resetting movement may be understood to mean the respectively opposite movement, in particular a retraction, inward movement or upward movement of the respective support wheel into a retracted height position.

In one exemplary embodiment, the traction mechanism kinematic system has two plates which are connected to one another by means of a hinge and of which at least one interacts with a spring bolt or pressure bolt of the side support apparatus. This permits a setting movement by means of a pivoting of at least one of the plates about the hinge. Aside from advantages relating to a compact structural form, there are also resulting possibilities for mounting at least one of the plates in preloaded fashion.

In one exemplary embodiment, a/the traction mechanism kinematic system, which interacts with the transmission device, of the side support apparatus has a pivoting or flap mechanism configured for coupling the transmission device to a two-wheeled vehicle drive traction mechanism. This provides, not least, good flexibility in terms of the design of the side support apparatus. For example, the transmission device can be designed specifically for one side of the two-wheeled vehicle, and then installed redundantly on both sides, wherein the traction mechanism kinematic system is configured for linking the two transmission devices, in particular for synchronous concurrent running, at least in certain portions or at least with regard to one movement direction, of the support wheels arranged at both sides.

In one exemplary embodiment, a/the traction mechanism kinematic system, which interacts with the transmission device, of the side support apparatus has two plates which are mounted articulatedly on one another and which serve for the positioning of at least one pinion in and out of engagement with a two-wheeled vehicle drive traction mechanism. The definition of a setting movement by means of at least one plate also provides, not least, a degree of accuracy and good robustness.

In one exemplary embodiment, a/the traction mechanism kinematic system, which interacts with the transmission device, of the side support apparatus has at least one plate, which is displaceable by a switching travel or by a setting movement of 1 to 2 cm (in translation and/or in rotation) for switching the transmission device, in particular a spring-mounted plate which is displaceable in a vertical direction. A switching travel of such magnitude firstly provides short switching travels and short switching times, and secondly, it is possible to ensure an adequate depth of engagement or a sufficiently great spacing of the pinion from the moving, possibly vibrating chain in an unlinked state. Here, the plate may be displaced in translation and/or in rotation in order to generate or set the switching travel.

In one exemplary embodiment, the transmission device and/or a/the traction mechanism kinematic system of the side support apparatus has at least one spring element configured for coupling the transmission device, in particular for coupling to a two-wheeled vehicle drive traction mechanism. A spring element can provide good robustness, freedom from maintenance or else a good setting force, and can be integrated into the overall system in an advantageous manner.

In one exemplary embodiment, the transmission device has a drive pinion which is mounted on a plate of the transmission device and which is configured for coupling to a two-wheeled vehicle drive traction mechanism. This provides an advantageous arrangement with regard to the further components of the transmission device and of the traction mechanism kinematic system. Preferably, the drive pinion is in this case arranged on a dome on the top of the plate such that a spring-mounted element can, by interaction with the dome, effect a switching travel or a setting movement of the drive pinion. The switching travel is, in this specific variant, initiated by a pressure force which acts on the plate from the outside.

In one exemplary embodiment, the transmission device has a drive pinion, a traction mechanism, in particular a chain, and at least one further pinion and a Bowden cable shaft and is configured for (un)coupling the Bowden cable shaft from a/the two-wheeled vehicle drive traction mechanism, in particular by means of a Bowden cable trigger. This permits not only simple operation and manually actuatable movement linking but also a transmission ratio. The Bowden cable trigger may in this case be integrated into, or linked to, a brake lever.

The movement linking of the movement of the two-wheeled vehicle drive traction mechanism to the setting movement of at least one support wheel may in this case also be realized in conjunction with a free backward running function (freewheeling during backpedaling). The free backward running function is preferably provided at or with a/the further transmission shaft, that is to say at a shaft which interacts rotationally conjointly with a traction mechanism guided over a/the Bowden cable shaft. A free backward running function provides the advantage that, when the stand mechanism is deployed, an interaction with the side support apparatus (retraction of the side stand mechanisms) occurs only in one direction of a pedaling movement, in particular during forward pedaling or when starting off, but not in the other direction (backpedaling or braking). Such a free backward running function (freewheeling during backpedaling) is advantageous in particular also when the two-wheeled vehicle has no backpedal brake, but in any case already exhibits freewheeling during backpedaling. This freewheeling may also be realized in the case of the side support apparatus, such that the function of the two-wheeled vehicle is not influenced in a restricting manner.

In one exemplary embodiment, the side support apparatus has a Bowden cable system which is linked to the transmission device and thus to the at least one support wheel and by means of which the at least two height positions are settable by a rider, in particular also during travel. This facilitates, not least, operation. The actuation of the side support apparatus may in this case be realized optionally entirely by mechanical and manual means.

In one exemplary embodiment, a/the Bowden cable system of the side support apparatus is linked to a brake or a brake lever of the two-wheeled vehicle, in particular is actuatable by means of the brake lever. This also provides an advantageous integration into existing components on a two-wheeled vehicle.

In one embodiment, a/the Bowden cable system of the side support apparatus interacts with a/the traction mechanism kinematic system configured for positioning in at least one of the height positions by reversible temporary linking to a two-wheeled vehicle drive traction mechanism. This provides not only a high level of robustness but also flexibility, be it with regard to the arrangement of the individual components or with regard to operation/actuation.

In one exemplary embodiment, the side support apparatus has a housing device configured for receiving the (respective) side stand mechanism, which housing device is arrangeable laterally at a wheel of the two-wheeled vehicle for the purposes of receiving the supporting wheel in the retracted height position above the ground contact point of the wheel, in particular at least 20 cm above the ground contact point. This provides protection and structure or stability for the individual components.

In one exemplary embodiment, a/the housing device of the side support apparatus is configured for receiving and supporting the transmission device and a/the traction mechanism kinematic system of the side support apparatus. This makes it possible for the forces that arise during the switching and during the onward transmission of forces and torques to be accommodated in the housing device. The travel characteristics of the two-wheeled vehicle remain unaffected by this.

In one exemplary embodiment, the housing device is configured for receiving at least two support wheels at both sides of a wheel of the two-wheeled vehicle in at least one of the height positions. This provides above-stated advantages also in the case of the support wheels being implemented on both sides or in redundant fashion.

In one exemplary embodiment, the side stand mechanism has a spring-mounted stand mechanism arm, in particular a stand mechanism arm which is spring-mounted under tension at both sides at two free ends. A preloaded mounting provides the advantage of a short reaction time and a simple form of the triggering of the movement linking. A bilateral mounting preloaded about a joint provides the advantage of a symmetrical introduction of force and low susceptibility to failure, or high robustness. It is preferable for two springs to engage on the stand mechanism arm, in particular for the purposes of a high spring force, stability and parallel guidance. It is optionally possible for only one spring to be used, in particular in a central arrangement, and/or an elastic band.

In one exemplary embodiment, the side stand mechanism has at least one spring, in particular tension spring functioning as a preload element for positioning the support wheel, in particular engaging on a/the stand mechanism arm of the side stand mechanism. This simplifies in particular the automatic deployment of a support wheel. Here, the positioning is performed preferably only by means of the spring force, that is to say in purely spring-driven fashion, until the wheel makes contact with the ground. Damping is not necessarily provided. The lowest, furthest-deployed height position may in this case be predefined by a linear toothing, in particular comprising a stop. The arrangement or length of the linear toothing may in this case also define the range of the settable height positions.

In one exemplary embodiment, the side stand mechanism has two spring bolts, of which one is arranged and configured to interact with at least one plate of a/the traction mechanism kinematic system, and of which the other is arranged and configured to interact with a blocking means of a linear toothing or of a detent means. This provides a kinematically advantageous interaction between the individual components.

In one exemplary embodiment, a/the Bowden cable shaft of the side support apparatus is configured for linking two support wheels, which are arrangeable at both sides of a wheel of the two-wheeled vehicle, of at least two side stand mechanisms of the side support apparatus. In this way, a drive movement of a drive traction mechanism can be easily distributed in redundant or at least two-branch fashion to at least two side stand mechanisms.

In one exemplary embodiment, the Bowden cable shaft is mounted at four bearings. This provides a stable mounting with the possibility of linking. Here, the respective diverting rollers may also be configured for tautening and guiding the traction cable. The respective cable may be guided through a flexible sheath channel from an actuating lever to the entrance of a/the housing device.

In one exemplary embodiment, the Bowden cable shaft has a pinion which is linked by means of a traction mechanism, in particular a chain, to a/the pinion of the transmission device. This permits the rotationally conjoint linking of the Bowden cable shaft to a rotational movement of a drive/output pinion of the transmission device.

In one exemplary embodiment, the Bowden cable shaft has three Bowden cable scrolls. This provides good order and reduces the risk of faults owing to incorrectly guided cables. The Bowden cable scrolls can make the respective cable available in preloaded fashion. The Bowden cable scrolls may each be formed in the manner of two disks, mounted on one another, with an interposed connecting shaft, on which shaft the cable can be wound up.

In one exemplary embodiment, the side stand mechanism has a cantilever which is preloadable by means of spring force and the position of which is linked to the height position of the at least one support wheel and which interacts with at least one positively locking triggering mechanism, in particular also with a detent means. This also provides a high degree of flexibility with regard to the arrangement and the interaction of the individual components.

In one exemplary embodiment, the side support apparatus has at least one Bowden cable tensioner configured for length compensation and tensioning over at least two cables which engage on a/the Bowden cable shaft of the side support apparatus, in particular of three cables. In this way, a working length (stroke) which is different in the individual cables can be compensated. It is also possible to ensure a certain preload in the respective cable. This has the result that, not least, the robustness and operational reliability are increased.

In one exemplary embodiment, the side support apparatus has three Bowden cable tensioners, each configured for tensioning and for the length compensation of a cable which engages on the Bowden cable shaft. This permits robust, reliable handling even of a multiplicity of cables which have been elongated, or are loaded, to different degrees.

In one exemplary embodiment, the side support apparatus is of bilateral design and has at least two side stand mechanisms which are arrangeable to the right and to the left of a wheel of the two-wheeled vehicle, wherein the transmission device is linked in each case to the at least one support wheel of the side stand mechanisms, wherein the transmission device is preferably linked to the support wheels such that synchronous, concurrent running of the support wheels occurs during the positioning of the support wheels. In this way, the two-wheeled vehicle can be supported in highly stable fashion and also vertically, without lateral inclination, in numerous situations, for example at a traffic signal, at a crossing, at a railroad crossing, or for the purposes of reading a map.

In one exemplary embodiment, a/the traction mechanism kinematic system of the side support apparatus couples the transmission device to at least two side stand mechanisms. This provides, not least, a compact construction of the overall arrangement.

At least one of the above-stated objects is also achieved by means of a side support apparatus for two-wheeled vehicles, said side support apparatus being configured for permanent installation on the two-wheeled vehicle and for laterally supporting the two-wheeled vehicle when stationary with or without a rider or during travel, wherein the side support apparatus has at least one side stand mechanism with at least one support wheel, which support wheel is positionable in at least one height position; wherein the side support apparatus has a transmission device which is linked to the support wheel and which is configured for positioning the support wheel in at least two height positions comprising at least one deployed supporting height position and at least one retracted height position for support-free travel with the two-wheeled vehicle, wherein the side support apparatus has a traction mechanism kinematic system configured for positioning the support wheel in at least one of the height positions by reversible temporary linking of the transmission device to a two-wheeled vehicle drive traction mechanism, wherein the traction mechanism kinematic system is manually linkable by means of an actuating device to the two-wheeled vehicle drive traction mechanism, wherein the traction mechanism kinematic system of the side support apparatus has two plates which are connected to one another by means of a hinge and by means of which the transmission device is switchable, wherein the side support apparatus, in particular the respective side stand mechanism, has at least one pressure bolt configured for displacing at least one of the plates for the purposes of coupling the transmission device. This provides advantages stated above.

At least one of the above-stated objects is also achieved by means of a side support apparatus for two-wheeled vehicles, said side support apparatus being configured for permanent installation on the two-wheeled vehicle and for laterally supporting the two-wheeled vehicle when stationary with or without a rider or during travel, wherein the side support apparatus has two side stand mechanisms each with at least one support wheel, which support wheel is respectively positionable in at least one height position; wherein the side support apparatus has a transmission device which is linked to the respective support wheel and which is configured for positioning the respective support wheel in at least two height positions comprising at least one deployed supporting height position and at least one retracted height position for support-free travel with the two-wheeled vehicle, wherein the side support apparatus has a traction mechanism kinematic system configured for positioning the respective support wheel in at least one of the height positions by reversible temporary linking of at least one pinion of the transmission device to a two-wheeled vehicle drive traction mechanism, wherein the traction mechanism kinematic system of the side support apparatus has two plates which are connected to one another by means of a hinge and by means of which the pinion can be placed in engagement with the two-wheeled vehicle drive traction mechanism, wherein the engaging pinion of the transmission device is arranged rotationally conjointly on a Bowden cable shaft on which three cables engage at three Bowden cable scrolls, wherein the side support apparatus is of bilateral design, wherein the transmission device is coupled to the support wheels such that synchronous, concurrent running of the support wheels is realized during the positioning of the support wheels. This provides advantages stated above.

At least one of the above-stated objects is also achieved by means of a two-wheeled vehicle having a side support apparatus as described above. This yields advantages stated further above.

At least one of the above-stated objects is also achieved by means of a control device configured for predefining a setting movement for actuating the transmission device of the side support apparatus, in particular by means of a traction mechanism kinematic system. This permits an even greater degree of automation. For example, a desired position can be transmitted by means of a speech command or an electronic input or an electronic signal to the control device, wherein the control device may also be linked to a Bowden cable system of the side support apparatus and to at least one drive, in particular an electric drive comprising at least one electric motor.

At least one of the above-stated objects is also achieved by means of a computer program product configured for predefining a control sequence or closed-loop control regime, wherein the computer program product may interact with or be stored in the control device described here, in particular on a data memory of the control device. This also permits programming of particular setting movements or setting forces, for example in a manner dependent on the size, the age, the weight of the rider or other parameters, for example the mass of the two-wheeled vehicle. By means of the computer program product, the method described here can be even more easily automated and at the same time also individualized.

At least one of the above-stated objects is accordingly also achieved by means of a data carrier having a computer program product of said type stored thereon or by means of a computer or a computer system or a virtual machine or at least one hardware element with the same.

At least one of the above-stated objects is also achieved by means of the use of a side support apparatus at a wheel of a two-wheeled vehicle with two side stand mechanisms arranged to the right and to the left of the wheel, in the case of which, manually by means of a Bowden cable system, at least one support wheel of the respective side stand mechanism is positionable in at least two height positions by means of a traction mechanism kinematic system which is actuated by the Bowden cable system and which is configured for reversible temporary linking of a transmission device of the side support apparatus to a two-wheeled vehicle drive traction mechanism, in particular the use of an above-described side support apparatus at a rear wheel of a bicycle, in particular installed on a luggage carrier and/or on wheel screws of the bicycle. This yields advantages stated above. Such use is not only expedient in the context of private use but may for example also provide a considerable saving of time or of expenditure of effort, or facilitation of work in general, in the logistics sector (letter or parcel delivery services). Aside from the effect of a reduced track width, in particular in relation to the three-wheeled vehicles that have hitherto customarily been used, it is also possible for good riding feel and good maneuverability to be appreciated. It can be cumbersome to actuate the side support apparatus every few meters in front of a respective house door. However, the side support apparatus provides considerable advantages in the handling of the two-wheeled vehicle at the latest in the case of relatively large distances between individual stopping points, for example above 30 or 100 m.

At least one of the above-stated objects is also achieved by means of the use of a resiliently elastically mounted traction mechanism kinematic system for providing a switchable support functionality of a side support apparatus on at least one wheel of a two-wheeled vehicle, wherein at least one support wheel is positionable in at least two predefinable height positions by means of a transmission device, which is switchably linkable to a two-wheeled vehicle drive traction mechanism of the two-wheeled vehicle, of the side support apparatus, in particular the use of the traction mechanism kinematic system in an above-described side support apparatus. This also provides a high degree of automatability.

At least one of the above-stated objects is, as mentioned, also achieved by means of a method for the (movement) linking of a transmission device of a side support apparatus to a two-wheeled vehicle drive traction mechanism for the side support of the two-wheeled vehicle, in particular by means of a/the traction mechanism kinematic system of an above-described side support apparatus, having the steps:

transmitting a setting movement of an actuating device to a traction mechanism kinematic system of the side support apparatus;
reversibly temporarily linking a transmission device of the side support apparatus to the two-wheeled vehicle drive traction mechanism by means of the traction mechanism kinematic system;
transmitting a drive movement of the two-wheeled vehicle drive traction mechanism by means of the transmission device to at least one side stand mechanism of the side support apparatus; and
positioning at least one support wheel of the at least one side stand mechanism in one of at least two height positions, in particular by means of the drive movement or by means of at least one spring element or spring bolt or spring preloaded by means of the drive movement. This yields advantages stated above. The actuating device may be manually operated. It is optionally also possible for the setting movement of the actuating device to be realized by motor means or in automated fashion, in particular in reaction to an electronic input or an electronic signal, such that a complete setting movement sequence from the actuation to the engagement of the transmission (switching travel) can be performed in automated fashion.

After the positioning in the respective height position, an unlinking of the transmission device from the two-wheeled vehicle drive traction mechanism can be performed by virtue a resetting displacement of the traction mechanism kinematic system being performed, in particular by virtue of a plate, which is mounted in preloaded fashion, of the traction mechanism kinematic system being released and pivoted back about a pivot bearing.

In one embodiment, one of the movements of the side stand mechanisms in a vertical direction, in particular the resetting movement (resetting displacement of the support wheels upward), is effected by means of a drive of the two-wheeled vehicle drive traction mechanism, and the opposite movements of the side stand mechanisms in the vertical direction, in particular the deployment, are effected in a manner driven by spring force by means of at least one preloaded spring. Here, the movement driven by spring force may be triggered by means of a lever or a manual or automatic actuation as a method step following the positioning.

In one embodiment, the transmission device is linked to a Bowden cable shaft which is in engagement with two side stand mechanisms for the simultaneous, in particular synchronous, height positioning of the support wheels. This yields advantages stated above.

### BRIEF DESCRIPTION OF THE FIGURES

In the figures of the drawing that follow, the invention will be described in more detail, wherein, for reference designations that are not explicitly described in a respective figure of the drawing, reference is made to the other figures of the drawing. In the figures, in each case in a schematic illustration:

FIGS. 1A, 1B, 1C, 1D, 1E, 1F show, in plan views and in side views, a transmission device of a side support apparatus according to an exemplary embodiment;

FIGS. 1G, 1H, 1J, 1K, 1L, 1M show, in side views, individual components of a traction mechanism kinematic system of a side support apparatus according to an exemplary embodiment in an actuated and a non-actuated state;

FIGS. 2A, 2B show, in each case in a plan view, a side support apparatus, arranged in a housing device and of bilateral design, according to an exemplary embodiment;

FIGS. 3A, 3B, 4A, 4B show, in each case in a side view, a side stand mechanism of a side support apparatus according to an exemplary embodiment, viewed from the left and from the right;

FIGS. 5A, 5B, 5C show, in each case in a rear view, components, arranged in a housing device, of a side support apparatus according to an exemplary embodiment, in each case illustrated only partially;

FIG. 6 shows, in a perspective view, a support device for receiving a side support apparatus according to an exemplary embodiment;

FIGS. 7A, 7B, 7C show, in a plan view, a side view and a rear view, components, arranged in a housing device, of a side support apparatus according to an exemplary embodiment;

FIG. 8 shows, in a schematic illustration, a Bowden cable system for a Bowden cable trigger of a side support apparatus according to an exemplary embodiment;

FIGS. 9A, 9B, 9C, 10 show, in each case in a plan view, a bicycle with a support device, installed thereon, for receiving a side support apparatus according to an exemplary embodiment, and with the side support apparatus;

FIGS. 11A, 11B show, in each case in a rear view, a bicycle with a side support apparatus according to an exemplary embodiment installed thereon, in different operating states;

FIG. 12 shows, in a rear view, a bicycle with a side support apparatus according to an exemplary embodiment installed thereon, in the case of which two side stand mechanisms have been deployed into different height positions;

FIG. 13 shows, in different views, a Bowden cable tensioner for use on a side support apparatus according to an exemplary embodiment; and

FIGS. 14A, 14B, 14C show, in each case in a perspective view, individual components of a side support apparatus according to an exemplary embodiment in an exploded illustration.

### MORE DETAILED DESCRIPTION OF THE FIGURES

The invention will be described below with reference to all figures. Special features of the invention will then be indicated with reference to individual figures. Here, dashed or dotted lines schematically indicate individual components, for the sake of completeness or better clarity. For the purposes of better clarity, the individual components are, in individual figures, illustrated at least partially on their own, that is to say not as a complete assembly.

A bicycle 1 has a frame 1.1, a handlebar 2, a wheel pinion 3 at the rear wheel 4 with a mudguard 4.1, a luggage carrier 5, a saddle 6 and a wheel axle 7 with wheel screws 7.1. On the handlebar 2, there is provided a brake lever 8, into which an actuating device 20 (described in more detail further below) can be integrated. The wheel pinion 3 may be driven by means of a two-wheeled vehicle drive traction mechanism 9 in the form of a bicycle chain (drive chain).

A side support apparatus 10 has a housing device 11, configured for receiving the components described in more detail below, with longitudinal struts 11.1 and transverse struts 11.2, in particular in the form of square-section profiles, and with a rear lighting luminaire 11.9. The housing device 11 may be produced for example from aluminum or fiber composite.

On the bicycle frame 1.1 there is provided a support device 12 with four mounting points 12.1, 12.2, 12.3, 12.4 which are designed for receiving hollow profiles and which are in particular U-shaped. One or more longitudinal members 12.6 and transverse members 12.5 can ensure a high degree of torsional stiffness and a front-end support 12.51 on the bicycle 1. By means of posts 12.7 and struts 12.8 and axle receptacles 12.9, in particular slotted lugs, forces can be transmitted onward into the bicycle frame 1.1.

The side support apparatus 10 has two side stand mechanisms 13, specifically a left-hand side stand mechanism 13A and a right-hand side stand mechanism 13B, in each case with a (in particular T-shaped) stand mechanism arm 13.1 which is guided for example in guide rails, a cantilever 13.5 which interacts in positively locking fashion with a blocking mechanism, and multiple spring bolts or pressure bolts 13.6 (installed or mounted in particular on the cantilever), specifically a first and second spring bolt 13.6A, 13.6B, wherein, in the second spring bolt 13.6B, there is arranged a counterbore 13.61 around which a spring 13.62 is arranged. A linear toothing 13.7 with detent means in the form of a toothed rack permits latching in different height positions. The linear toothing 13.7 can be immobilized and unblocked by means of a ratchet fastener 13.72 in operative connection with one of the spring bolts 13.6B. The stand mechanism arm 13.1 is coupled by means of two springs 13.8, in particular tension springs, to the housing device 11. A support wheel 13.9 is connected by means of a vertical bearing support 13.73 to the stand mechanism arm 13.1. The linear toothing 13.7 may furthermore have a blocking means. The respective stand mechanism furthermore preferably has a receiving plate, a slide plate and a guide rail.

The side support apparatus 10 comprises a transmission device 14 with a transmission shaft 14.1, an engagement pinion 14.11 configured for engaging into a/the drive traction mechanism 9, a dome 14.2 (which dome may also be provided as a component of the traction mechanism kinematic system), a drive pinion 14.3 which is mounted rotationally conjointly on the transmission shaft 14.1 and which serves for transmitting a speed-increased or speed-reduced drive movement by means of at least one traction mechanism 14.4 to an output pinion 14.5, wherein the output pinion 14.5 or a further output pinion 14.6 (mounted in particular on the same shaft 14.8) is, by means of a traction mechanism 14.7, in operative connection with a drive pinion 16.6, which is mounted rotationally conjointly on a Bowden cable shaft 16.1. The Bowden cable shaft 16.1 may also be provided as a constituent part of the traction mechanism kinematic system 15. The further output pinion 14.6 may provide a further transmission ratio stage. The dome 14.2 may interact with one of the spring bolts 13.6A of the side stand mechanism 13, in particular by virtue of the spring bolt 13.6A exerting a pressure force on the dome 14.2 from above and thereby actuating the traction mechanism kinematic system described below.

The side support apparatus 10 furthermore comprises a traction mechanism kinematic system 15 with a first plate 15.1 and a second (lower) plate 15.2 mounted thereon by means of a pivot hinge 15.3 and in which there are provided multiple bores 15.21 and sleeves 15.22 for receiving pressure springs 15.23, such that the upper plate 15.1 can be spring-mounted relative to the lower plate 15.2. The sleeves permit guidance of the springs independently of the orientation of the upper plate 15.1. The sleeves also provide a receiving cavity for the springs in the case of the plates being fully closed and bearing against one another.

Several of the above-described components of the transmission device 14, in particular also the dome 14.2 and the transmission shaft 14.1, are mounted on the upper plate. Via the dome 14.2, it is thus possible for the transmission shaft 14.1 to be actuated indirectly by means of the spring bolt 13.6A. Multiple cables or chains 15.6, 15.61, 15.62, 15.63 of the traction mechanism kinematic system 15 are guided over a Bowden cable shaft 16.1 (described in more detail further below), wherein, in the case of each side stand mechanism 13A, 13B, in each case one cable 15.62, 15.63 is guided through the respective spring bolt 13.6B, such that the respective spring bolt 13.6B can be preloaded by means of the cable. For example, for this purpose, the cable is provided with a knot or a cable clamp at the free end below the spring bolt, such that the cable is fixable in an axially fixed manner to the spring bolt at least in one movement direction. The cables 15.6 can in this case ensure a link between the traction mechanism kinematic system 15 and the Bowden cable system 16 or the Bowden cable shaft 16.1. The cables 15.6 provide an output-side link, that is to say at the output side of the transmission device 14 or at the output side of the traction mechanism kinematic system 15, to the respective side stand mechanism 13A, 13B.

A spring-mounted triggering mechanism 15.8 in the form of a non-positively and positively locking holding clamp has a housing 15.81 and a spring element 15.82 and a bolt 15.83 with a bevel 15.84. A cable can be guided over a diverting rollers 15.87 in order to thus displace the bolt counter to the spring force and in order to thus permit a displacement of the respective support wheel into a particular height position or in order to prevent a displacement. Likewise, a spring-mounted triggering mechanism 15.9 in the form of a non-positively and positively locking spring clamp has a housing 15.91, a spring element 15.92 and a bolt 15.93 with a bevel 15.94, which bolt is likewise actuatable by means of a diverting roller 15.97 and a cable.

A Bowden cable trigger 15.5 which is integrable into or arrangeable adjacent to the brake lever 8 may in particular also be fixed, so as to be settable into different tension positions, by clamping means, in particular pointed screws.

The side support apparatus 10 furthermore comprises a Bowden cable system 16 for coupling multiple side stand mechanisms, wherein kinematic linking may be performed by means of a Bowden cable shaft 16.1 on which at least one idling roller 16.4 for guiding a cable is provided. The Bowden cable shaft 16.1 is linked by means of a drive pinion 16.6 to a drive pinion 14.5, 14.6 of the transmission device 14. The kinematic system may have one or more bearings for a kinematic link, in particular bearings for the Bowden cable shaft.

The side support apparatus 10 furthermore comprises an actuating device 20 with an actuating lever 21, in particular in the form of a brake lever or of a further lever coupled to the brake lever, and with a Bowden cable 23 with at least one individual cable 15.6, 23.1 and a connecting piece 23.4 or a distributor for splitting the individual cable 15.6, 23.1 into multiple cables or Bowden cables. By means of the Bowden cable 23, it is possible for further individual cables 23.2, 23.3 to be actuated, which are operatively connected to the clamps and/or triggering mechanisms 15.8, 15.9. The individual cable 23.2 may in this case correspond to the cable 15.61 guided over the Bowden cable shaft 16.1. The respective individual cable may be guided through a bore or guide in the inside of the respective bolt 15.93 and fixed thereto, for example by means of a clamping screw.

An actuation of the traction mechanism kinematic system 15 may be performed manually and/or at least partially by means of a drive 30, wherein the control device 40 can predefine the nature of the actuation or the time or the duration of an engagement, in particular on the basis of specifications from a data memory with regard to at least two different operating states or rider profiles.

The side support apparatus 10 extends transversely with respect to the direction of travel along a transverse axis x, and in the direction of travel along a longitudinal axis y, wherein the support wheels 13.9 are displaced in a z direction (vertical axis). The absolute dimensions of the side support apparatus 10 in the x direction may be described as track width. The track width lies for example in the region of 660 mm.

Special features of the invention will now be indicated below with reference to individual figures.

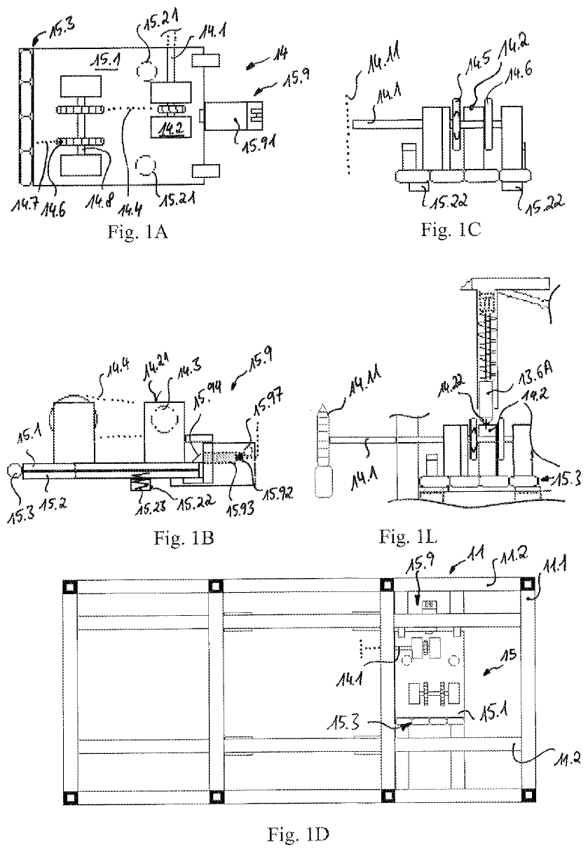

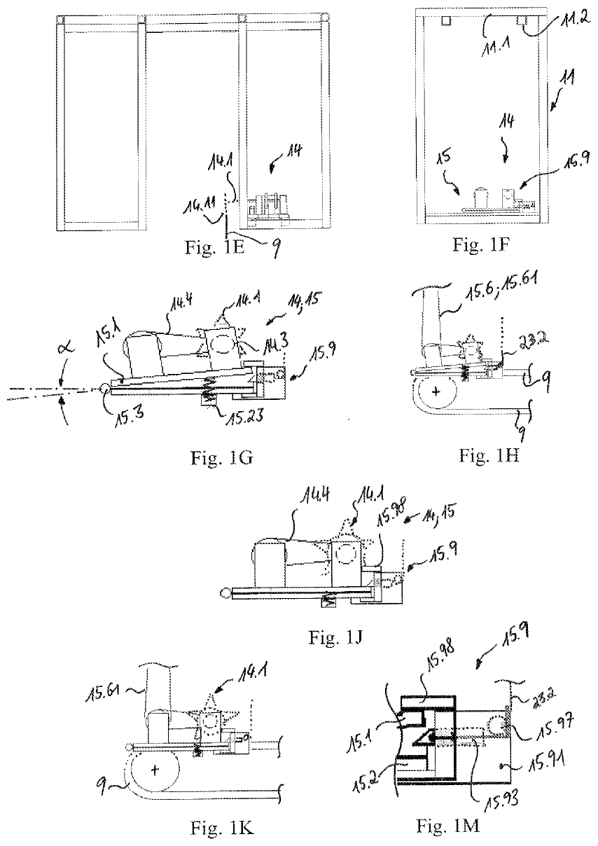

FIG. 1A shows the transmission device 14 in a plan view, wherein the individual components of the transmission device 14, which interact with traction mechanisms or cables and ensure movement linking, are arranged on the upper plate 15.1. It is possible to clearly see the dome 14.2 with an abutment surface 14.21 and with a pressure point 14.22 for the spring bolt 13.6A (FIGS. 1B and 1L).

FIG. 1B shows an arrangement of the traction mechanism kinematic system 15 in a blocked position, with engagement of the engagement pinion 14.11 from above into the bicycle chain 9. The holding bolt 15.93 blocks the upper plate 15.1 counter to the preload force of the spring 15.23.

FIGS. 1C and 1L show the transmission device 14 and the traction mechanism kinematic system 15 from a rear view, likewise in the blocked state, that is to say in engagement. The upper plate 15.1 has not been pivoted out upward.

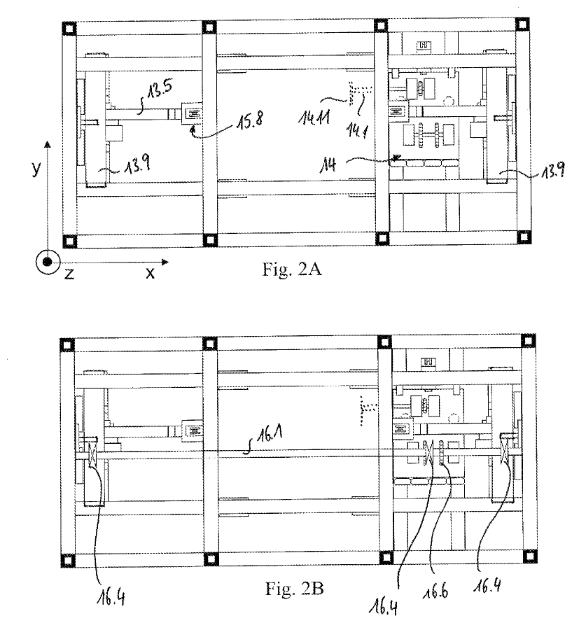

FIG. 1D shows the arrangement of the transmission device 14 and of the traction mechanism kinematic system 15 in a housing device 11. It can be seen that only one transmission device 14 and only one traction mechanism kinematic system 15 are required on one side in order to be able to actuate side stand mechanisms on both sides. Movement linking of the two sides is realized by means of the shaft 16.1 shown in FIG. 2B.

FIGS. 1E and 1F show the arrangement of the transmission device 14 and of the traction mechanism kinematic system 15 in the housing device 11 relative to a drive traction mechanism 9 of the two-wheeled vehicle. The traction mechanism kinematic system 15 is arranged such that the transmission device 14 can be placed into engagement with the drive traction mechanism 9 from above. In this way, the engagement pinion 14.11 can engage into the loaded portion of the chain 9 (load strand). This also provides advantages with regard to compactness and weight/mass of the overall arrangement.

FIGS. 1G and 1H show the traction mechanism kinematic system 15 in the open state, without engagement. The pinion 14.11 has been displaced upward and is no longer situated in engagement with the chain 9. The two plates have been pivoted out by a switching angle α in the range of 10 to 20° about the pivot bearing 15.3 and elastically preloaded relative to one another in this arrangement. Here, the upper plate abuts against a stop or a holding bracket 15.98. The corresponding pinion has, in this arrangement of the upper plate, been pivoted away from the bicycle chain, such that no engagement into the bicycle chain occurs.

FIGS. 1J, 1K, 1L show the traction mechanism kinematic system 15 in a closed state with plates bearing against one another, with engagement of the corresponding pinion 14.11 into the bicycle chain 9. The pinion is positioned on the chain, that is to say engages into the chain from above, in this case specifically in the loaded portion of the chain (load strand). No engagement takes place in the non-loaded portion (idle strand).

It can be seen in FIG. 1L that a pressure bolt 13.6A acts on the upper plate 15.1 from above and thereby closes the traction mechanism kinematic system. After the closure, a spring-mounted holding pin or bolt 15.93 acts on the upper plate and holds the latter closed until the holding pin is displaced out of the holding position counter to an elastic preload, in particular by actuation of a Bowden cable system by means of an actuating lever, whereby the corresponding cable 23.2 is pulled and the upper plate 15.1 is released in order to pivot back upward in a spring-driven manner. The pressure bolt is preferably composed of inelastic, non-deformable material.

FIG. 1M shows the nature of the interaction of the components of the triggering mechanism 15.9 which is actuatable by means of the Bowden cable. A spring-mounted holding pin 15.93 can be actuated by means of a cable 23.2 which is linked via a diverting roller 15.97 to a shaft or a Bowden cable. During the pivoting-closed of the two plates, that is to say during the actuation of the traction mechanism kinematic system by means of the pressure bolt 13.6A, the holding pin is pushed back counter to a spring preload and locks the plates as soon as these bear against one another. The holding pin can be pulled back into the open position by means of the cable for the opening or pivoting-back of the plates. The plates spring open, and the pinion is separated from the chain (unlinking).

FIG. 2A shows components of the transmission device 14 and of the side wall structure 13 in a plan view.

FIG. 2B shows the Bowden cable shaft 16.1 which links the two side stand mechanisms 13A, 13B to one another.

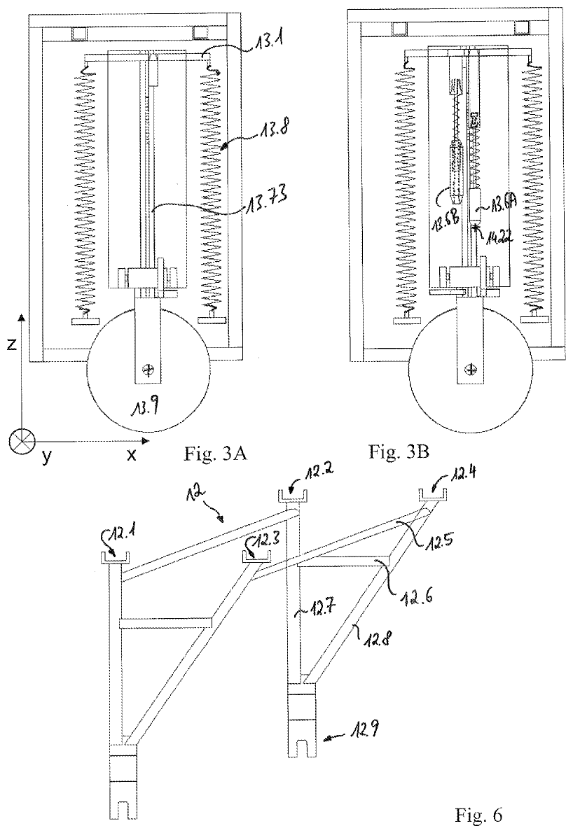

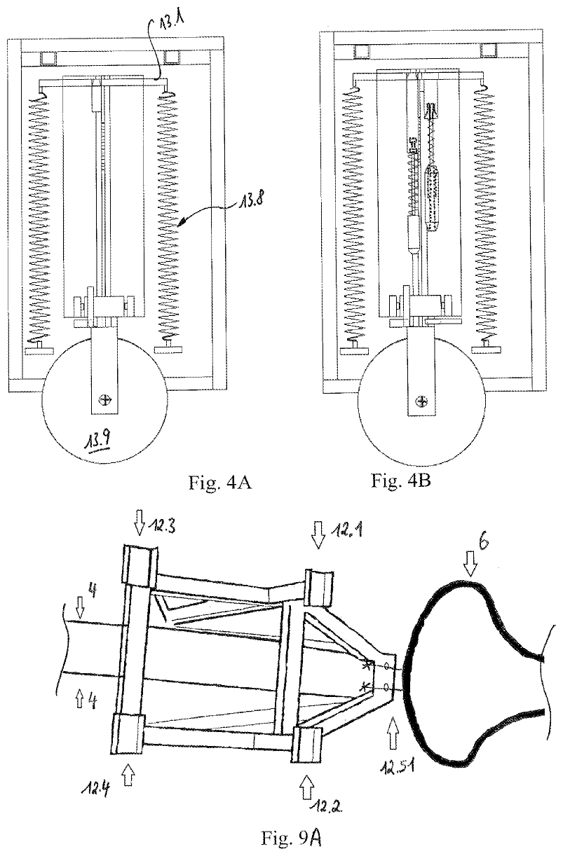

FIGS. 3A, 3B show the spring mounting of support wheel 13.9 and bearing support 13.73. The spring force of the springs 13.8 can be utilized to deploy the support wheels 13.9 in any traveling situation as far as the underlying surface, optionally also into different height positions in the case of an uneven underlying surface. FIG. 3B shows the kinematic system by means of spring bolts 13.6A, 13.6B. FIGS. 4A and 4B show the arrangement as in FIGS. 3A, 3B, in an opposite viewing direction.

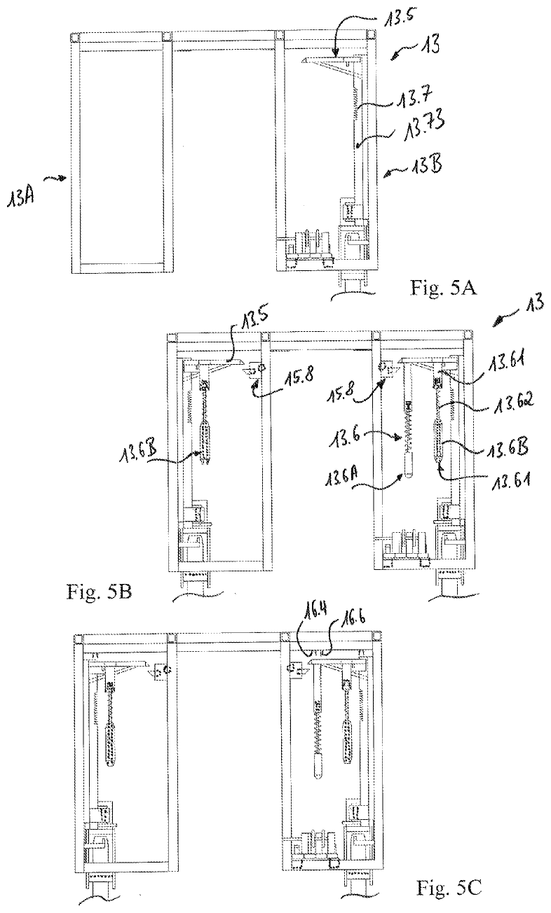

FIG. 5A shows, as an individual component on its own, one of the two side stand mechanisms 13B with the linear toothing 13.7 formed on the bearing support 13.73. FIG. 5B additionally shows the nature of the engagement of the cantilever 13.5 with the triggering mechanism 15.8. FIG. 5C additionally shows the Bowden cable shaft 16.1 or individual pinions or rollers 16.4, 16.6. For the purposes of improved clarity, springs, traction mechanisms or cables or further components of the Bowden cable system are not illustrated.

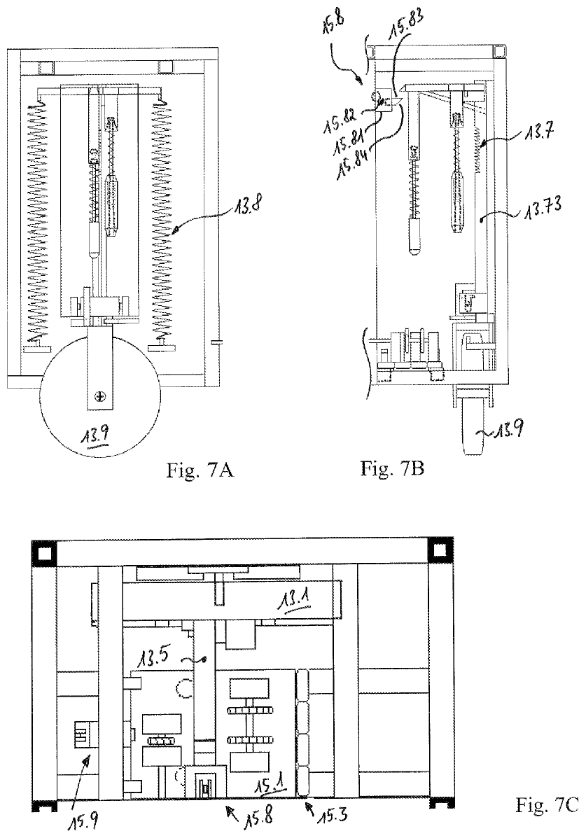

FIGS. 5A to 5C and FIG. 7B show the functioning of the spring-mounted bolts 13.6A, 13.6B. The transmission pressure bolt 13.6A arranged above the transmission device 14 is arranged and configured to actuate the traction mechanism kinematic system 15 and thus indirectly also to switch the transmission device 14. The transmission pressure bolt 13.6A permits movement linking between side stand mechanism 13, traction mechanism kinematic system 15 and transmission device 14. The transmission device 14 can in this case be closed/locked by means of the bolt 15.93 with the engagement pinion 14.11 in engagement with the chain 9, such that the respective side stand mechanism can be preloaded counter to the spring force of the springs 13.8 into an upper, retracted height position.

The spring-mounted bearing support 13.73 of the respective side stand mechanism 13A, 13B is arranged and configured to compensate an unevenness of the underlying surface and thus to set an adequate height difference of the two side stand mechanisms 13A, 13B. Here, it is for example possible for a height difference of ±5 cm per side to be compensated, as shown in FIG. 12. This also permits holding in an upright position on an inclined plane. The pressure bolt 13.6B in this case interacts with the linear toothing 13.7. The pressure bolt 13.6B (ratchet opening bolt) has, in particular, a spring travel in the range of 10 to 12 cm.

In this regard, it is possible here, by way of example, to describe three height positions at the linear toothing 13.7: in an upper position, the deployment travel of the corresponding side stand mechanism is lengthened, for example by 5 cm. In a middle position, the end position of the corresponding support wheel is brought into line with the height position of the bottom side (or of the ground contact point) of the rear wheel of the bicycle. In a lower position, the deployment travel of the corresponding side stand mechanism is shortened, for example by 5 cm.

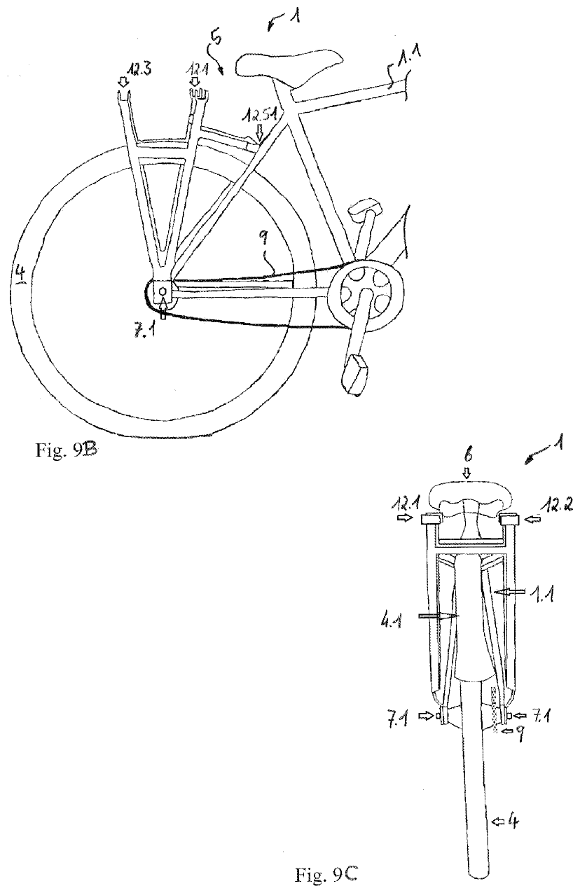

FIG. 6 shows individual components of the support device 12, in an embodiment as a luggage carrier or as a device for installation at or above a luggage carrier. FIGS. 9A, 9B and 9C show one of several possible types of installation on a two-wheeled vehicle.

FIGS. 7A, 7B, 7C show details of the interaction of individual components for the movement linking.

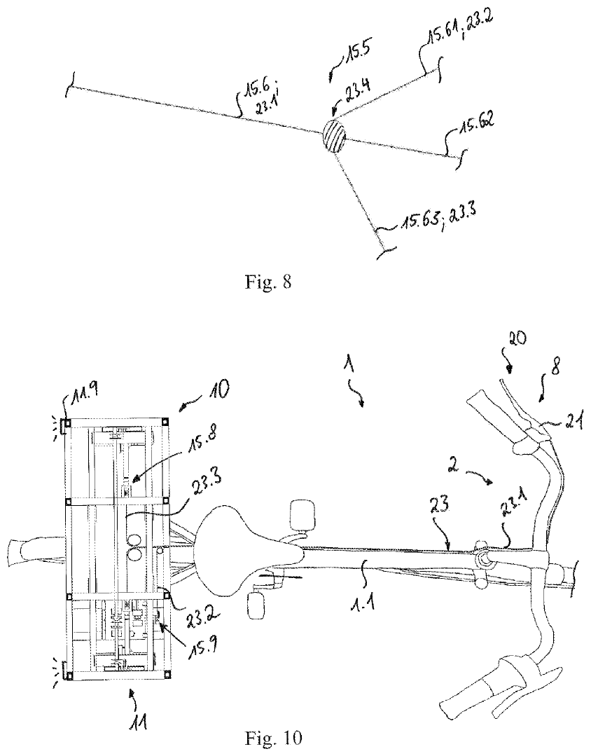

FIG. 8 shows, by way of example, a Bowden cable with various cables, be it for transmitting an actuating movement onward to the clamps 15.8, 15.9 or for transmitting a setting movement onward to the respective side stand mechanism. The respective clamp 15.8, 15.9 may have a longitudinal bore and a lateral bore for the arrangement and relative guidance of the corresponding component.

FIG. 10 shows movement linking of an actuating device 20 and the triggering mechanisms 15.8, 15.9, wherein the guidance of the individual cables 23.1, 23.2, 23.3 may also be varied in accordance with the nature of the desired actuation, with further speed increase/speed reduction ratios or diversions.

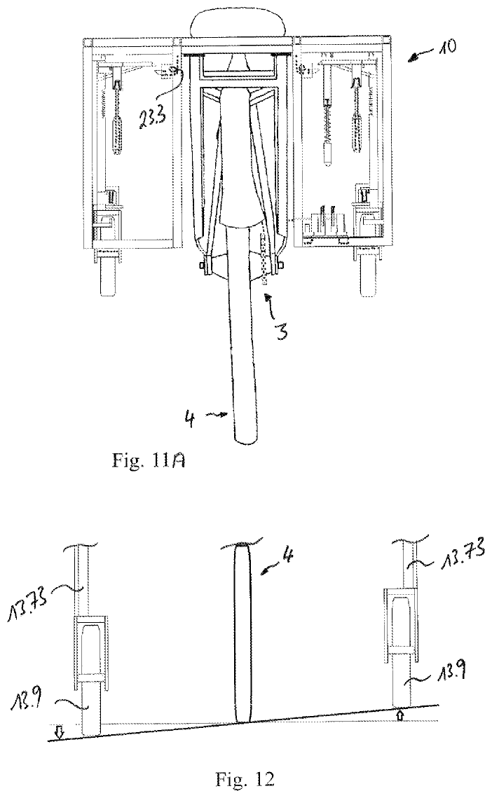

FIG. 11A shows, in a rear view, an arrangement in an upper height position, without engagement. FIG. 11B shows the bicycle with deployed side stand mechanism 13, in the case of engagement of the traction mechanism kinematic system or of the transmission device into the bicycle chain 9, such that, now, when the bicycle chain 9 is driven, the support wheels 13.9 can, again in preloaded fashion counter to a spring force, be displaced into a desired upper retracted height position, in particular automatically when starting off. An upper stop edge of the pressure bolt 13.6B in this case interacts with the ratchet fastener 13.72 and releases the latter, that is to say unblocks the immobilized carrier 13.73.

If the stand mechanisms 13A, 13B are in a deployed state, then the bolt 13.6A of one stand mechanism 13B pushes the two transmission plates 15.1, 15.2 together. Here, the holding pin 15.93 is initially pushed back on the tip of the transmission plates. When the two plates have moved fully together, the holding pin 15.93 is abruptly driven forward by spring force of the spring element 15.82 and locks the two plates against one another. The contact pinion 14.11 now lies on the chain 9. As a result of the cranking of the pedals in the direction of travel, the chain moves the contact pinion, and the Bowden cable shaft 16.1 is driven via the transmission 14. The two cables 15.62, 15.63 of the stand wheels 13.9 now retract the stand wheels. This is a fully automatic process.

An unlinking from the bicycle chain 9 may take place as follows. The two stand mechanisms are at rest in a retracted, upper height position. By means of the Bowden cable trigger 15.5, a displacement downward (a deployment) can be triggered. If the Bowden cable shaft 16.1 now draws in the respective cable, the two stand mechanisms are pulled upward by a good 2 cm beyond the original height position. The further cable 15.61 or 23.2 is thereupon also tensioned, which further cable is connected to the holding pin of the transmission. The holding pin 15.93 is in this case pulled back such that the transmission springs open and the engagement pinion 14.11 is separated from the chain 9. The two stand mechanisms can thereupon fall back to their retracted height position again.

The spring 13.63 of the pressure bolt 13.6A is stronger than the springs 15.23 of the transmission plate. The springs 13.62 of the two ratchet opening bolts 13.6B are stronger than the springs 13.8 of the stand mechanisms. The ratchet opening bolts can slide past the ratchet 13.7 during the deployment of the support wheels. The side support apparatus may be adapted such that, after the triggering by the Bowden cable trigger 15.5, the stand mechanisms 13A, 13B deploy as quickly as possible, in particular in the range of tenths of a second.

The detent means 13.7 may have a ratchet which is arranged in a housing and which may be in the form of a small plate with a hooked form in the direction of the toothed rack. The small plate is pressed by means of a small spring against the toothing and thus forms the ratchet fastener. The housing has a bore through which a bolt protrudes during the deployment of the stand mechanism. If the stand mechanism is to be retracted, the corresponding cable pulls on the bolt and then protrudes into the bore again upwardly from below. A cone of the bolt presses against the small plate, which is set into an oblique position by the small spring, and said cone orients said small plate specifically such that the hooked form is released from the toothed rack of the stand mechanism. The ratchet is thus released again.

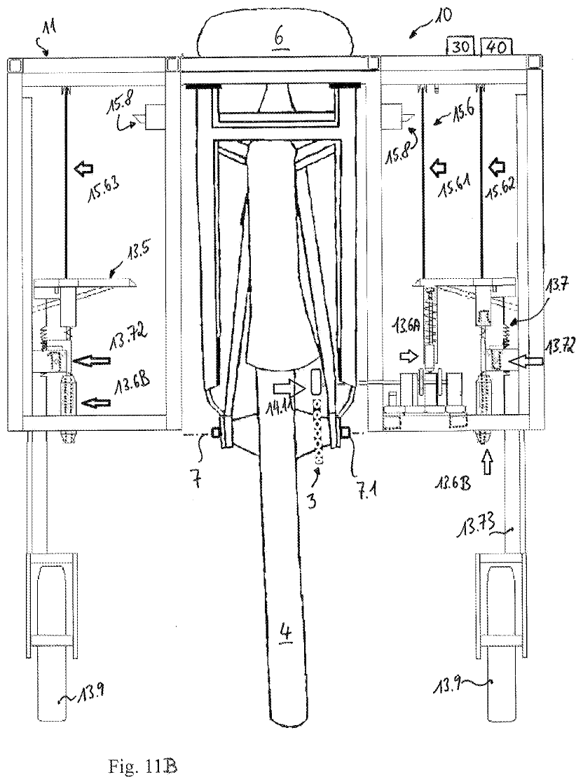

FIG. 13 shows, by way of example, a Bowden cable tensioner 16.9 with a diverting roller 16.91, a spring-mounted (pivot) hinge 16.92 and a spring 16.93. During the pivoting, slack can be drawn out of a cable guided over the diverting rollers 16.91. The Bowden cable tensioner is configured to compensate different working lengths of multiple cables and to hold each of the cables under tension. Such a Bowden cable tensioner is expedient in particular for the cable that actuates the plate of the traction mechanism kinematic system, in particular because said cable has a long length and can thus be held under tension.

FIGS. 14A, 14B, 14C show the functioning of individual components. FIG. 14A describes the construction of the transmission device 14 and of the Bowden cable system 16 in a generalized manner separately from the traction mechanism kinematic system. FIG. 14B illustrates the individual directions of rotation and the tension forces acting on or exerted by the individual traction mechanisms. FIG. 14C describes, by way of example, transmission ratio stages between the individual components. The transmission ratio may also be selected to be greater or smaller depending on the application.

### LIST OF REFERENCE DESIGNATIONS

1 Two-wheeled vehicle, in particular bicycle
1.1 Frame
2 Handlebar
3 Wheel pinion, in particular at the rear wheel
4 Wheel
4.1 Mudguard
5 Luggage carrier, in particular at the rear wheel
6 Saddle
7 Wheel axle, in particular at the rear wheel
7.1 Wheel screw
8 Brake lever
9 Two-wheeled vehicle drive traction mechanism, in particular bicycle chain (drive chain) or drive belt
10 Side support apparatus
11 Housing device, in particular trunk
11.1 Longitudinal strut
11.2 Transverse strut
11.9 Rear lighting luminaire
12 Support device, in particular carrier or frame supported on both sides
12.1, 12.2, 12.3, 12.4 Mounting points for housing device
12.5 Transverse member, in particular U-shaped or hollow profile
12.51 Front-end support
12.6 Longitudinal member, in particular U-shaped or hollow profile
12.7 Post
12.8 Strut
12.9 Axle receptacle, in particular slotted lug, in particular for hub screws
13 Side stand mechanism
13A Left-hand side stand mechanism
13B Right-hand side stand mechanism
13.1 Stand mechanism arm
13.5 Cantilever
13.6 Spring bolt or pressure bolt
13.6A First spring bolt
13.6B Second spring bolt
13.61 Counterbore
13.62 Spring
13.63 Spring
13.7 Detent means or linear toothing, in particular toothed rack
13.72 Triggering mechanism, in particular ratchet fastener
13.73 Vertical bearing support
13.8 Spring, in particular tension spring
13.9 Support wheel
14 Transmission device, in particular with at least two transmission ratio stages
14.1 Transmission shaft
14.11 Engagement pinion
14.2 Dome
14.21 Abutment surface
14.22 Pressure point
14.3 Drive pinion
14.4 Traction mechanism, in particular drive chain
14.5 Output pinion
14.6 Further output pinion
14.7 Traction mechanism, in particular output chain
14.8 Further transmission shaft
15 Traction mechanism kinematic system
15.1 First plate
15.2 Second (lower) plate
15.21 Bore
15.22 Sleeve
15.23 Spring, in particular pressure spring
15.3 Hinge
15.5 Bowden cable trigger
15.6, 15.61, 15.62, 15.63 Cable
15.8 Spring-mounted triggering mechanism, in particular non-positively and positively locking holding clamp
15.81 Housing
15.82 Spring element
15.83 Bolt
15.84 Bevel
15.87 Diverting roller
15.9 Spring-mounted triggering mechanism, in particular non-positively and positively locking fixing clamp
15.91 Housing
15.92 Spring element
15.93 Bolt
15.94 Bevel
15.97 Diverting roller
15.98 Stop or holding bracket
16 Bowden cable system for coupling multiple side stand mechanisms
16.1 Kinematic link, in particular Bowden cable shaft
16.4 Idling roller
16.6 Drive pinion
16.9 Bowden cable tensioner
16.91 Diverting roller
16.92 Hinge
16.93 Spring
20 Actuating device
21 Actuating lever, in particular brake lever or linked to brake lever
23 Bowden cable
23.1, 23.2, 23.3 Individual cable
23.4 Connecting piece
30 Drive
40 Control device
x Longitudinal axis/direction
y Transverse axis/direction or width axis
z Vertical axis
α Switching angle

1. A side support apparatus (10) for two-wheeled vehicles, configured for permanent installation on the two-wheeled vehicle and for laterally supporting the two-wheeled vehicle when stationary with or without a rider or during travel, wherein the side support apparatus has at least one side stand mechanism (13) with at least one support wheel (13.9), which support wheel is positionable in at least one height position;
characterized in that the side support apparatus is switchable and has a transmission device (14) which is linked to the support wheel and which is configured for positioning the support wheel in at least two height positions comprising at least one deployed supporting height position and at least one retracted height position for support-free travel with the two-wheeled vehicle.

2. The side support apparatus as claimed in claim 1, wherein the side support apparatus, in particular the transmission device (14), provides at least two functionalities from the following group: movement linking of the movement of a two-wheeled vehicle drive traction mechanism to a setting movement of at least one support wheel, linking of a manual actuating device to a two-wheeled vehicle drive traction mechanism for the switching of the transmission device, elastic spring mounting for the resiliently elastic positioning of the support wheel in at least one setting movement direction, elastic preloading of at least one spring of the side support apparatus in a first setting movement direction and resiliently elastic setting movement in a second setting movement direction; and/or wherein at least one functionality of the side support apparatus from the following group is switchable: elastic spring preload induced by a movement of a two-wheeled vehicle drive traction mechanism, resiliently elastic resetting movement by unblocking of a positively lockingly and/or non-positively locking triggering mechanism, displacement of at least one support wheel in a first setting movement direction and/or second setting movement direction by means of a two-wheeled vehicle drive traction mechanism.

3. The side support apparatus as claimed in claim 1, wherein at least one triggering mechanism or at least one pivoting movement of a traction mechanism kinematic system of the side support apparatus and/or the functionality of the transmission device (14) is activatable in spring-mounted fashion, in particular in each case a setting movement and/or a resetting movement for the positioning of the support wheel in the respective height position.

4. The side support apparatus as claimed in claim 1, wherein the side support apparatus has a traction mechanism kinematic system which is linked to the transmission device (14) such that the side support apparatus is configured for movement linking between a two-wheeled vehicle drive traction mechanism and the support wheel.

5. The side support apparatus as claimed in claim 1, wherein the side support apparatus is configured for movement linking between a/the two-wheeled vehicle drive traction mechanism (9) and at least one height position by means of a drive train at least comprising a/the transmission shaft (14.11), which engages into the two-wheeled vehicle drive traction mechanism, a/the Bowden cable shaft (16.1), which is driven by the transmission shaft, and a/the pressure bolt (13.6B), which is displaceable by means of the Bowden cable shaft, for releasing a triggering mechanism (13.72), in particular in this drive sequence for the movement linking in series in this sequence, in particular linked to an actuating device (20) which engages on at least one triggering mechanism.

6. The side support apparatus as claimed in claim 1, wherein the transmission device (14) is configured for transmitting a drive movement of a two-wheeled vehicle drive traction mechanism (9) to the at least one side stand mechanism; and/or wherein the side support apparatus has a traction mechanism kinematic system (15) configured for positioning the support wheel in at least one of the height positions by reversible temporary linking of the transmission device to a two-wheeled vehicle drive traction mechanism, in particular to a bicycle chain; and/or wherein the traction mechanism kinematic system (15) is manually linkable to the two-wheeled vehicle drive traction mechanism (9) by means of an actuating device (20), in particular by means of an actuating lever (21) arranged on a handlebar (2) of the two-wheeled vehicle (1).

7. The side support apparatus as claimed in claim 1, wherein a/the traction mechanism kinematic system (15), which interacts with the transmission device (14), of the side support apparatus has two plates (15.1, 15.2) which are connected to one another by means of a hinge (15.3) and by means of which the transmission device is switchable; and/or wherein the traction mechanism kinematic system (15) has two plates (15.1, 15.2) which are connected to one another by means of a hinge (15.3) and of which at least one interacts with a spring bolt or pressure bolt (13.6) of the side support apparatus; and/or wherein a/the traction mechanism kinematic system (15), which interacts with the transmission device (14), of the side support apparatus has two plates which are mounted articulatedly on one another and which serve for the positioning of at least one pinion (14.3) in and out of engagement with a two-wheeled vehicle drive traction mechanism (9); and/or wherein the transmission device (14) and/or a/the traction mechanism kinematic system (15) of the side support apparatus has at least one spring element (15.23) configured for coupling the transmission device, in particular for coupling to a two-wheeled vehicle drive traction mechanism; and/or wherein the transmission device has a drive pinion (14.3) and a traction mechanism (14.3), in particular a chain, and at least one further pinion (14.5, 14.6) and a Bowden cable shaft (16.1) and is configured for coupling the Bowden cable shaft from a/the two-wheeled vehicle drive traction mechanism, in particular by means of a Bowden cable trigger (15.5).

8. The side support apparatus as claimed in claim 1, wherein the side support apparatus has a Bowden cable system (16) which is linked to the transmission device and thus to the at least one support wheel and by means of which the at least two height positions are settable by a rider, in particular also during travel; and/or wherein a/the Bowden cable system (16) of the side support apparatus is linked to a brake or a brake lever (8) of the two-wheeled vehicle, in particular is actuatable by means of the brake lever; and/or wherein a/the Bowden cable system (16) of the side support apparatus interacts with a/the traction mechanism kinematic system (15) configured for positioning in at least one of the height positions by reversible temporary linking to a two-wheeled vehicle drive traction mechanism (9).

9. The side support apparatus as claimed in claim 1, wherein the side stand mechanism has a spring-mounted stand mechanism arm (13.1), in particular a stand mechanism arm which is spring-mounted under tension at both sides at two free ends; and/or wherein the side stand mechanism has at least one spring (13.8), in particular tension spring functioning as a preload element for positioning the support wheel, in particular engaging on a/the stand mechanism arm (13.1) of the side stand mechanism; and/or wherein the side stand mechanism has two spring bolts (13.6), of which one is arranged and configured to interact with at least one plate (15.1) of a/the traction mechanism kinematic system (15), and of which the other is arranged and configured to interact with a blocking means (13.71) of a linear toothing or of a detent means (13.7).

10. The side support apparatus as claimed in claim 1, wherein the side stand mechanism has a cantilever which is preloadable by means of spring force and the position of which is linked to the height position of the at least one support wheel and which interacts with at least one positively locking triggering mechanism, in particular also with a detent means.

11. The use of a side support apparatus at a wheel (4) of a two-wheeled vehicle (1) with two side stand mechanisms (13A, 13B) arranged to the right and to the left of the wheel, in the case of which, manually by means of a Bowden cable system (16), at least one support wheel (13.9) of the respective side stand mechanism is positionable in at least two height positions by means of a traction mechanism kinematic system (15) which is actuated by the Bowden cable system and which is configured for reversible temporary linking of a transmission device of the side support apparatus to a two-wheeled vehicle drive traction mechanism (9), in particular the use of a side support apparatus (10) as claimed in any of the preceding claims at a rear wheel of a bicycle, in particular installed on a luggage carrier (5) and/or on wheel screws (7.1) of the bicycle.

12. The use of a resiliently elastically mounted traction mechanism kinematic system (15) for providing a switchable support functionality of a side support apparatus on at least one wheel (4) of a two-wheeled vehicle (1), wherein at least one support wheel is positionable in at least two predefinable height positions by means of a transmission device, which is switchably linkable to a two-wheeled vehicle drive traction mechanism (9) of the two-wheeled vehicle, of the side support apparatus, in particular the use of the traction mechanism kinematic system in a side support apparatus (10) as claimed in any of the preceding claims.

13. A method for the linking of a transmission device (14) of a side support apparatus to a two-wheeled vehicle drive traction mechanism (9) for the side support of a two-wheeled vehicle (1), in particular by means of a/the traction mechanism kinematic system (15) of a side support apparatus (10) as claimed in any of the preceding claims,
characterized by the steps:
transmitting a setting movement of an actuating device (20) to a traction mechanism kinematic system (15) of the side support apparatus;
reversibly temporarily linking a transmission device (14) of the side support apparatus to the two-wheeled vehicle drive traction mechanism (9) by means of the traction mechanism kinematic system (15);
transmitting a drive movement of the two-wheeled vehicle drive traction mechanism (9) by means of the transmission device (14) to at least one side stand mechanism (13A, 13B) of the side support apparatus; and
positioning at least one support wheel (13.9) of the at least one side stand mechanism in one of at least two height positions.
